(19) United States
(12) Patent Application Publication
(10) Pub. No.: US 2018/0335089 A1
(43) Pub. Date: Nov. 22, 2018

(54) STRUT BEARING CAP WITH ASSEMBLY FEATURE AND METHOD OF ASSEMBLING A STRUT BEARING ASSEMBLY

(71) Applicant: Schaeffler Technologies AG & Co. KG, Herzogenaurach (DE)

(72) Inventors: Shakeel Shaikh, Windsor (CA); Alaa Makke, Farmington Hills, MI (US); Andreas Woellner, Nuernberg (DE); Gerhard Meyer, Lehrberg (DE)

(73) Assignee: Schaeffler Technologies AG & Co. KG, Herzogenaurach (DE)

(21) Appl. No.: 15/596,122

(22) Filed: May 16, 2017

(51) Int. Cl. F16C 35/04; B23P 19/10; F16C 19/10; G01B 21/16; B60G 15/06

(52) U.S. Cl. CPC F16C 35/042; B23P 19/10; F16C 19/10; G01B 21/16; B60G 2204/418; F16C 2326/05; F16C 2226/12; B60G 2204/128; B60G 15/067

(57) ABSTRACT

A strut bearing, including: an axis of rotation; cap; a body portion; and a bearing fixed to the strut bearing cap and to the body portion. The cap includes: a first radial surface facing in a first axial direction; a plurality of ribs; a plurality of spaces, each space circumferentially disposed between a respective pair of ribs; and a plurality of radial recess surfaces. Each rib includes: a radial rib surface extending radially outwardly from the first radial surface; and a slant surface extending from the radial rib surface partly radially outwardly and partly in a second axial direction, opposite the first axial direction. Each radial recess surface: faces in the first axial direction; is circumferentially disposed between two respective ribs; and is off-set, in the second axial direction, from the first radial surface.

### TECHNICAL FIELD

The present disclosure relates to a strut bearing cap with at least one assembly features including expanded radial surfaces for intercepting a top mount bolt head and an indentation for enhancing operation of a vision system. The present disclosure also relates to a method of assembling a strut bearing assembly including a strut bearing cap with an assembly feature.

### BACKGROUND

FIG. 27 is a perspective view of prior art strut bearing 500. FIG. 28 is a cross-sectional view of prior art strut bearing 500 in FIG. 27 and prior art top mount 200 for a strut assembly misaligned. Bearing 500 includes: cap 501 with radial surface 502 facing in axial direction AD1; ribs 504; rib surfaces 506 extending partly radially outwardly and partly in axial direction AD2 (opposite direction AD1) from surface 502; and recessed radial surfaces 508. Mount 200 includes portion 202 with surface 204 facing in direction AD2. Bolts 206 with bolt heads 207 extend through portion 202 and past surface 204. In the example of FIG. 28, there would be three bolts 206, one for each surface 508.

During fabrication of a strut assembly, top mount 200 is press-fitted with bearing 500, in particular with cap 501. If bearing 500 and mount 200 are properly aligned in a circumferential direction (not shown), bolts 206 are axially aligned with respective surfaces 508, and bolt heads 207 extend past surface 502 without contacting rib surfaces 506.

If bearing 500 and mount 200 are not properly aligned in circumferential direction CD, as shown in FIG. 27, bolts 206 contact respective surfaces 506. For example, in FIG. 28, bolt head 207 in FIG. 28 is contacting surface 506A of rib 504A. When bolt heads 207 contact surfaces 506, press force PF causes bolts 206 to crush the contacted surfaces 506, and mount 200 and cap 501 are not properly joined together.

A known vision system (not shown) is used to evaluate the proper circumferential alignment and connection of bearing 500 and mount 200. The accuracy of the vision system is limited by the sensitivity distance of the system, which is the smallest incremental distance the system can calculate/measure. Thus, an actual distance equal to a whole number multiple of the sensitivity distance plus a fraction of the sensitivity distance is measured as only the whole number multiple (fractions of the sensitivity distance are truncated). To check alignment of cap 501 and mount 200, the vision system measures a distance between a reference point for the system and surface 502. When bearing 500 and mount 200 are circumferentially misaligned, the contact of bolts 206 with surfaces 506 causes surface 502 to be further away from the reference point than is the case for proper circumferential alignment. That is, the contact with surfaces 506 prevents bolts 206 (and mount 200) from displacing toward cap 501 as far is the case for proper circumferential alignment of bearing 500 and mount 200. However, the difference between the distance measured by the vision system for proper circumferential alignment and the distance measured by the vision system for circumferential misalignment is less than the sensitivity distance of the vision system. Therefore, the vision system is unable to distinguish between proper and improper circumferential alignment and is unable to flag misaligned strut bearings and top mounts before the bearings and mounts proceed further in the assembly process.

### SUMMARY

According to aspects illustrated herein, there is provided a strut bearing, including: an axis of rotation; cap; a body portion; and a bearing fixed to the strut bearing cap and to the body portion. The cap includes: a first radial surface facing in a first axial direction; a plurality of ribs; a plurality of spaces, each space circumferentially disposed between a respective pair of ribs; and a plurality of radial recess surfaces. Each rib includes: a radial rib surface extending radially outwardly from the first radial surface; and a slant surface extending from the radial rib surface partly radially outwardly and partly in a second axial direction, opposite the first axial direction. Each radial recess surface: faces in the first axial direction; is circumferentially disposed between two respective ribs; and is off-set, in the second axial direction, from the first radial surface.

According to aspects illustrated herein, there is provided a strut bearing, including: an axis of rotation; a cap; a body portion arranged to be fixed to a top mount for a strut assembly; and; a bearing fixed to the strut bearing cap and to the body portion. The cap includes: a first radial surface facing in a first axial direction and including a radially outermost edge and a radially innermost edge; a plurality of ribs, each rib extending from the radially outermost edge partly radially outwardly, and partly in a second axial direction, opposite the first axial direction; an indentation in the first radial surface, the indention including an edge forming a portion of the radially outermost edge; a plurality of spaces, each space circumferentially disposed between a respective pair of ribs; and a plurality of radial recess surfaces. Each radial recess surface: faces in the first axial direction; is circumferentially disposed between two respective ribs; and is off-set, in the second axial direction, from the first radial surface.

According to aspects illustrated herein, there is provided a strut bearing, including: an axis of rotation; a cap; a body portion arranged to be fixed to a top mount for a strut assembly; and; a bearing fixed to the strut bearing cap and to the body portion. The cap includes: a first radial surface facing in a first axial direction; a plurality of ribs; an indentation extending in the second axial direction and with a first portion in the first radial surface and a second portion in a radial rib surface for a first rib; a plurality of spaces, each space circumferentially disposed between a respective pair of ribs; and a plurality of radial recess surfaces. Each rib includes: a radial rib surface extending radially outwardly from the first radial surface; and a slant surface extending from the radial rib surface partly radially outwardly and partly in a second axial direction, opposite the first axial direction. Each radial recess surface: faces in the first axial direction; is circumferentially disposed between two respective ribs; and is off-set, in the second axial direction, from the first radial surface.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a top view of a strut bearing with an assembly feature;

FIG. 2 is perspective view of the strut bearing in FIG. 1;

FIG. 3 is a cross-sectional view generally along line 3-3 in FIG. 1;

FIG. 4 is a top view of the strut bearing in FIGS. 1 through 3 connected to a top mount for a strut assembly and with the strut bearing properly circumferentially aligned with the top mount;

FIG. 5 is a cross-sectional view generally along line 5-5 in FIG. 4;

FIG. 6 a top view of the strut bearing in FIGS. 1 through 3 connected to a top mount for a strut assembly and with the strut bearing circumferentially misaligned with the top mount;

FIG. 7 is a cross-sectional view generally along line 7-7 in FIG. 6;

FIGS. 8A and 8B are respective schematic block diagrams depicting assembly of the strut bearing and top mount shown in FIGS. 4 through 7;

FIG. 9 is a top view of a strut bearing with an assembly feature;

FIG. 10 is perspective view of the strut bearing in FIG. 9;

FIG. 11 is a cross-sectional view generally along line 11-11 in FIG. 9;

FIG. 12 is a top view of the strut bearing in FIGS. 9 through 11 connected to a top mount for a strut assembly and with the strut bearing properly circumferentially aligned with the top mount;

FIG. 13 is a cross-sectional view generally along line 13-13 in FIG. 12;

FIG. 14 a top view of the strut bearing in FIGS. 9 through 11 connected to a top mount for a strut assembly and with the strut bearing circumferentially misaligned with the top mount;

FIG. 15 is a cross-sectional view generally along line 15-15 in FIG. 14;

FIGS. 16A and 16B are respective schematic block diagrams depicting assembly of the strut bearing and top mount shown in FIGS. 12 through 15;

FIG. 17 is a top view of a strut bearing with two assembly features;

FIG. 18 is perspective view of the strut bearing in FIG. 17;

FIG. 19 is a cross-sectional view generally along line 19-19 in FIG. 17;

FIG. 20 is a top view of the strut bearing in FIGS. 17 through 19 connected to a top mount for a strut assembly and with the strut bearing properly circumferentially aligned with the top mount;

FIG. 21 is a cross-sectional view generally along line 21-21 in FIG. 20;

FIG. 22 is a cross-sectional view generally along line 22-22 in FIG. 20

FIG. 23 is a top view of the strut bearing in FIGS. 17 through 20 connected to a top mount for a strut assembly and with the strut bearing circumferentially misaligned with the top mount;

FIG. 24 is a cross-sectional view generally along line 24-24 in FIG. 23;

FIGS. 25A and 25B are respective schematic block diagrams depicting assembly of the strut bearing and top mount shown in FIGS. 17 through 24;

FIG. 26 is a perspective view of a prior art cylindrical coordinate system demonstrating spatial terminology used in the present application;

FIG. 27 is a top view of a prior art strut bearing; and,

FIG. 28 is a cross-sectional view of the prior art strut bearing in FIG. 27 and a prior art top mount for a strut assembly circumferentially misaligned.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

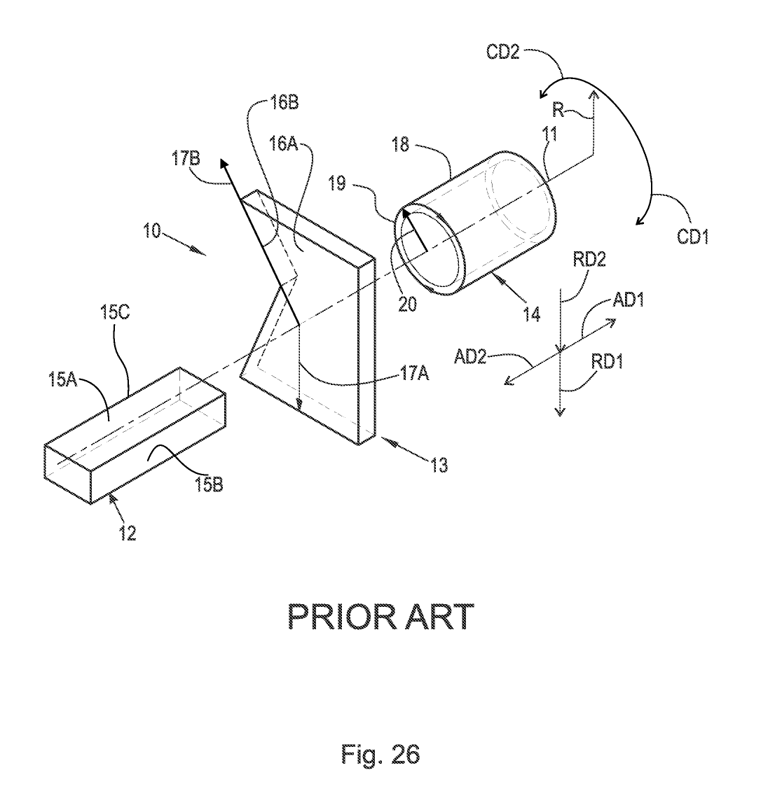

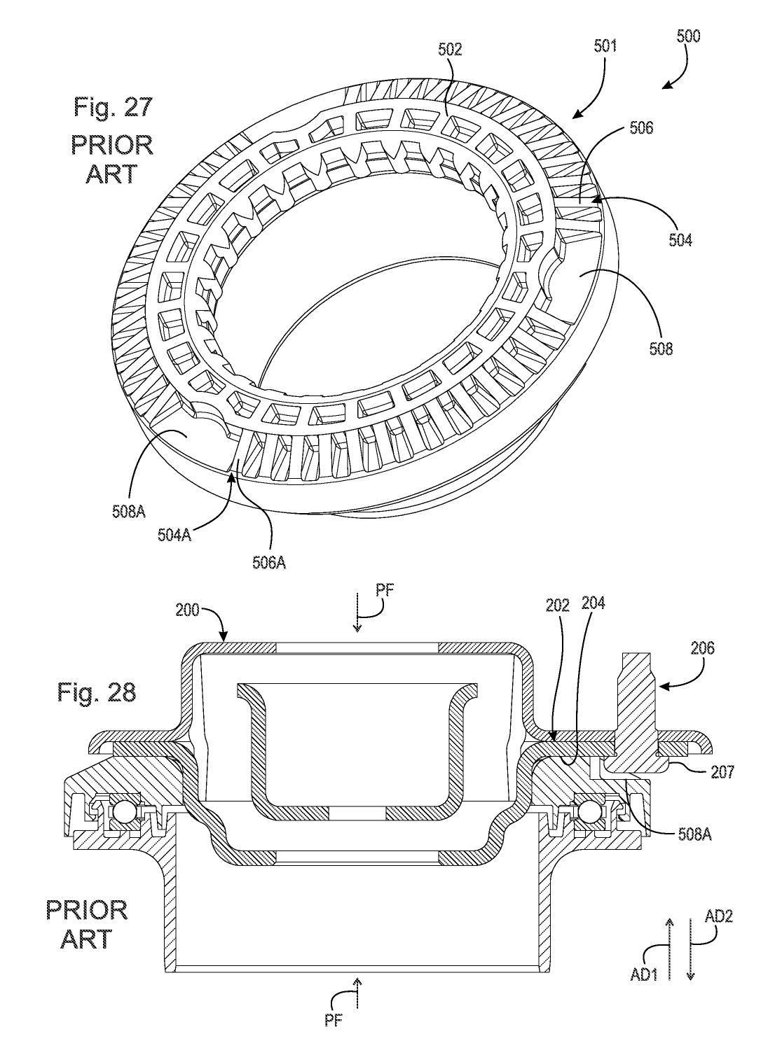

FIG. 26 is a perspective view of prior art cylindrical coordinate system 10 demonstrating spatial terminology used in the present application. The present application is at least partially described within the context of a cylindrical coordinate system. System 10 includes axis of rotation, or longitudinal axis, 11, used as the reference for the directional and spatial terms that follow. Opposite axial directions AD1 and AD2 are parallel to axis 11. Radial direction RD1 is orthogonal to axis 11 and away from axis 11. Radial direction RD2 is orthogonal to axis 11 and toward axis 11. Opposite circumferential directions CD1 and CD2 are defined by an endpoint of a particular radius R (orthogonal to axis 11) rotated about axis 11, for example clockwise and counterclockwise, respectively.

To clarify the spatial terminology, objects 12, 13, and 14 are used. As an example, an axial surface, such as surface 15A of object 12, is formed by a plane co-planar with axis 11. However, any planar surface parallel to axis 11 is an axial surface. For example, surface 15B, parallel to axis 11 also is an axial surface. An axial edge is formed by an edge, such as edge 15C, parallel to axis 11. A radial surface, such as surface 16A of object 13, is formed by a plane orthogonal to axis 11 and co-planar with a radius, for example, radius 17A. A radial edge is co-linear with a radius of axis 11. For example, edge 16B is co-linear with radius 17B. Surface 18 of object 14 forms a circumferential, or cylindrical, surface. For example, circumference 19, defined by radius 20, passes through surface 18.

Axial movement is in direction axial direction AD1 or AD2. Radial movement is in radial direction RD1 or RD2. Circumferential, or rotational, movement is in circumferential direction CD1 or CD2. The adverbs “axially,” “radially,” and “circumferentially” refer to movement or orientation parallel to axis 11, orthogonal to axis 11, and about axis 11, respectively. For example, an axially disposed surface or edge extends in direction AD1, a radially disposed surface or edge extends in direction RD1, and a circumferentially disposed surface or edge extends in direction CD1.

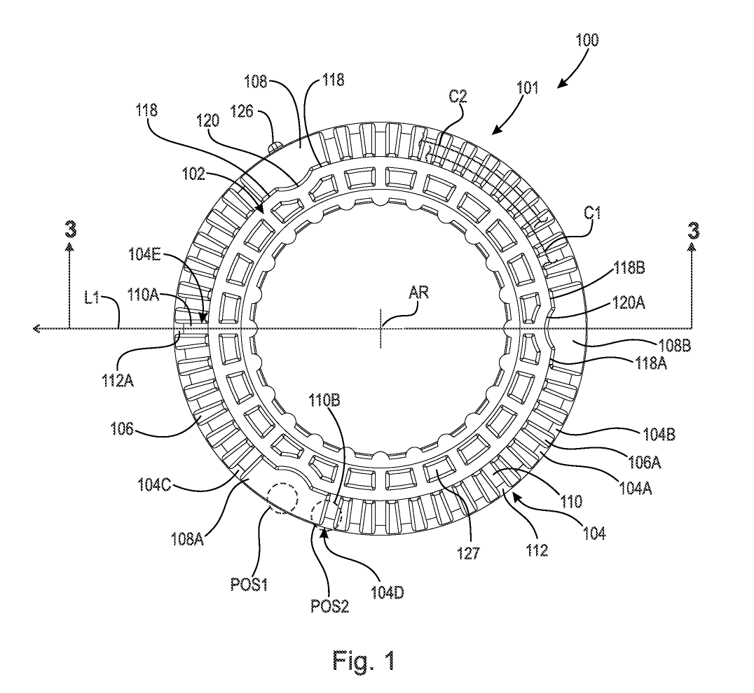

FIG. 1 is a top view of strut bearing 100 with an assembly feature.

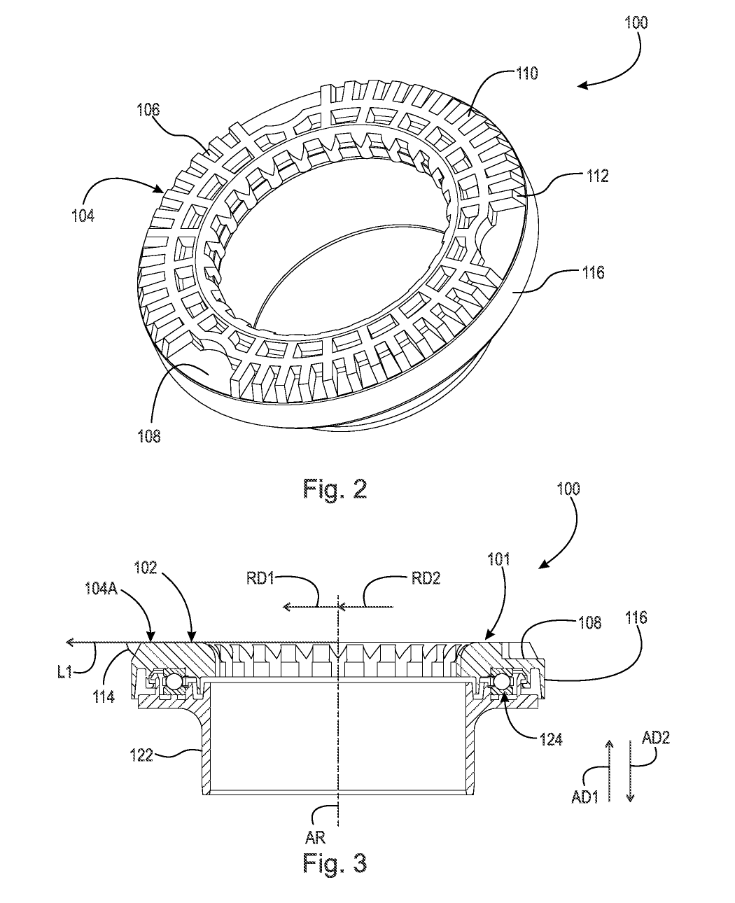

FIG. 2 is perspective view of strut bearing 100 in FIG. 1.

FIG. 3 is a cross-sectional view generally along line 3-3 in FIG. 1. The following should be viewed in light of FIGS. 1 through 3. Bearing 100 includes cap 101 and axis of rotation AR. Cap 101 includes: radial surface 102 facing in axial direction AD1; ribs 104 extending radially outwardly from radial surface 102; spaces 106; and radial recess surfaces 108. Each rib 104 includes radial rib surface 110 extending radially outwardly from radial surface 102 and slant surface 112 extending from surface 110 partly radially outwardly in radial direction RD1 and partly in axial direction AD2, opposite axial direction AD1. In an example embodiment, surfaces 110 are continuous with surface 102, that is, each radial rib surface 110 is directly connected to radial surface 102. Each space 106 is circumferentially disposed between a respective pair of ribs 104, for example, space 106A is circumferentially disposed between ribs 104A and 104B. Each radial recess surface 108: faces in axial direction AD1; is circumferentially disposed between two respective ribs 104; and is off-set, in axial direction AD2, from radial surface 102. For example, surface 108A is circumferentially disposed between ribs 104C and 104D.

Circle C1, centered on axis of rotation AR (formed by rotating a radius about axis AR) is co-linear with radial rib surfaces 110. Circle C2, centered on axis of rotation AR and axially off-set from circle C1, is co-linear with slant surfaces 112. Only respective portions of circles C1 and C2 are shown in order to avoid cluttering FIG. 1 and obscuring other features of cap 101. In an example embodiment, line L1, orthogonal to axis of rotation AR (for example, line L1 is a radius from axis AR) is co-linear with radial surface 102 and a radial rib surface 110, for example, surface 110A of rib 104E. Line L1 forms acute angle 114 with a slant surface 112, for example, surface 112A of rib 104E.

Cap 101 includes radially outermost circumferential surface 116. In an example embodiment, spaces 106 are open to radially outermost circumferential surface 116. In an example embodiment, ribs 104, in particular surfaces 112, extend to surface 116.

Cap 101 includes circumferential walls 118 and 120. Circumferential walls 118 directly connect radial recess surfaces 108 to radial surface 102. In an example embodiment, curved walls 120: are circumferentially disposed between a respective pair of circumferential walls 118; are directly connected to the respective pair of circumferential walls 118; are directly connected to radial surface 102 and a respective recess radial surface 108; and extend radially inwardly in radial direction RD2 from the respective pair of circumferential walls 118. For example, wall 120A is circumferentially disposed between and directly connected to circumferential walls 118A and 118B; is directly connected to radial surface 102 and recess radial surface 108B; and extends radially inwardly from circumferential walls 118A and 118B. In an example embodiment, radial recess surfaces 108 extend to radially outermost circumferential surface 116.

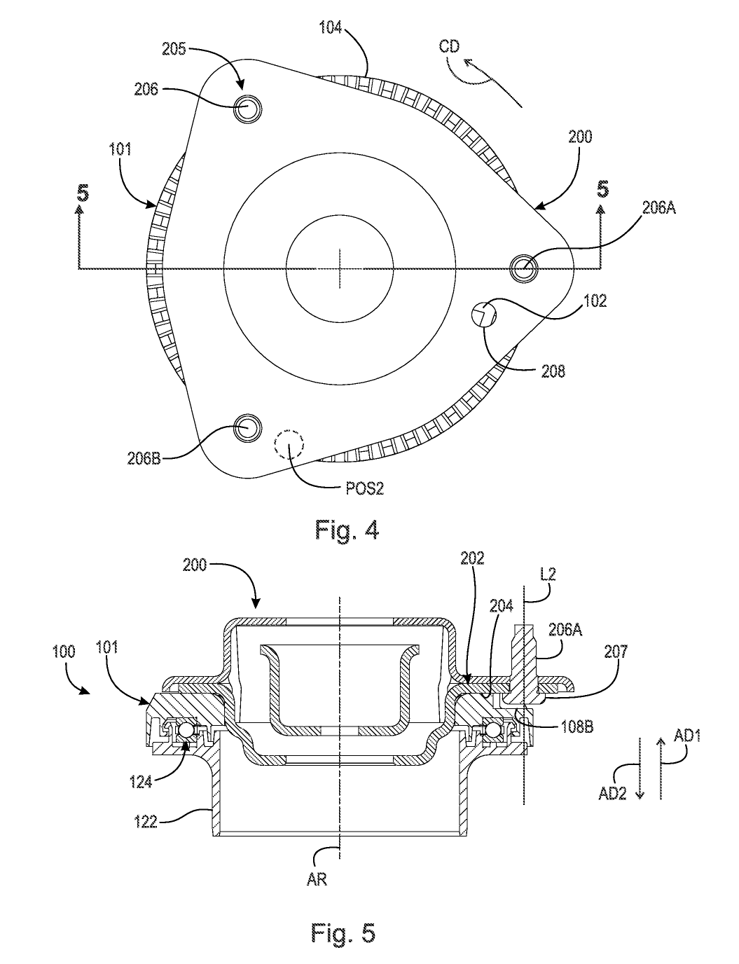

FIG. 4 is a top view of strut bearing 100 in FIGS. 1 through 3 connected to top mount 200 for a strut assembly and with strut bearing 100 properly circumferentially aligned with the top mount.

FIG. 5 is a cross-sectional view generally along line 5-5 in FIG. 4. The following should be viewed in light of FIGS. 1 through 5. Bearing 100 includes body portion 122 and bearing 124 between cap 101 and portion 122. In an example embodiment, bearing 124 is a roller bearing. In an example embodiment, surface 116 includes protrusion 126 extending radially outwardly. Protrusion 126 is used to manually align bearing 100 during the process of connecting bearing 100 to top mount 200. In an example embodiment, cap 101 includes indentations 127 circumferentially disposed about surface 102 and extending in direction AD2.

Mount 200 includes: portion 202 with surface 204 facing in direction AD2; and portion 205. Bolts 206 extend through portion 202 and past surface 204 in direction AD2. Each bolt 206 includes bolt head 207. During fabrication of a strut assembly, top mount 200 is press-fitted with bearing 100, in particular with cap 101. To implement the press fit, bearing 100 is moved in axial direction AD1 toward mount 200, or mount 200 is moved in direction AD2 toward bearing 100. If bearing 100 and mount 200 are properly aligned in circumferential direction CD1, for example as shown in FIGS. 4 and 5, an entirety of bolts 206 and bolt heads 207, is axially aligned with and overlaps, in axial directions AD1 and AD2, respective surfaces 108. Then, bolts 206 and bolt heads 207 extend past surfaces 102 and 110 in direction AD2 without contacting surfaces 102 or 110. For example, every line parallel to axis AR, passing through a bolt head 207 also passes through a respective surface 108; for example, every line L2 passing through bolt head 207 for bolt 206A also passes through surface 108B.

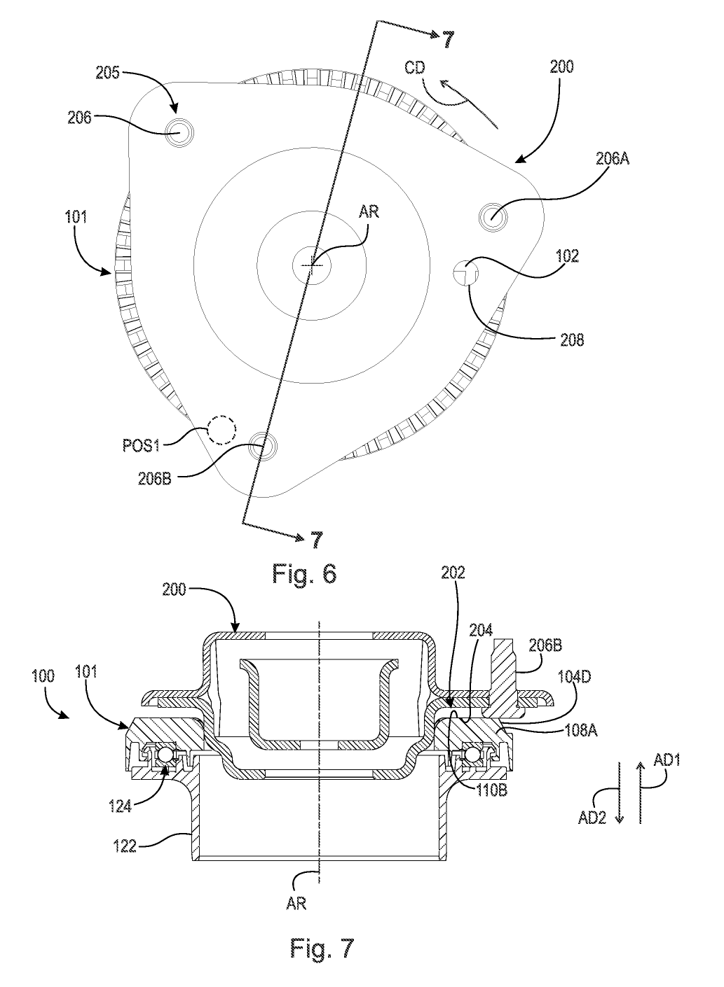

FIG. 6 a top view of strut bearing 100 in FIGS. 1 through 3 connected to top mount 200 for a strut assembly and with strut bearing 100 circumferentially misaligned with top mount 200.

FIG. 7 is a cross-sectional view generally along line 7-7 in FIG. 6. The following should be viewed in light of FIGS. 1 through 7. In FIGS. 6 and 7, a circumferential misalignment of mount 200 with bearing 100 is depicted. As shown in FIG. 7, bolt head 207 for bolt 206B has contacted surface 110B for rib 104D instead of being axially aligned with surface 108A. As further discussed below, the contact of bolt head 207 for bolt 206B (and the other bolt heads 207 with respective ribs 104) increases an axial distance between bearing 100 and mount 200.

In FIG. 1, position POS1, shown with dashed lines, shows the proper circumferential alignment of bolt 206B with surface 108A as depicted in FIGS. 4 and 5. In FIGS. 1 and 4, position POS2, shown with dashed lines, shows an example of a circumferential misalignment between bearing 100 and mount 200 as depicted in FIGS. 6 and 7, which results in bolt 206B contacting surface 110B of rib 104D. For example, as compared to the configuration in FIG. 4, top mount 100 is rotated in circumferential direction CD. Note that although not shown in FIG. 1, for POS2 of bolt 206B, all of bolts 206 would be shifted in circumferential direction CD (matching the shift of bolt 206B) with respect to the proper alignment of FIGS. 4 and 5. It should be understood that other degrees of misalignment between cap 101 and mount 200 in direction CD are possible and that misalignment between cap 101 and mount 200 is possible in a direction opposite direction CD.

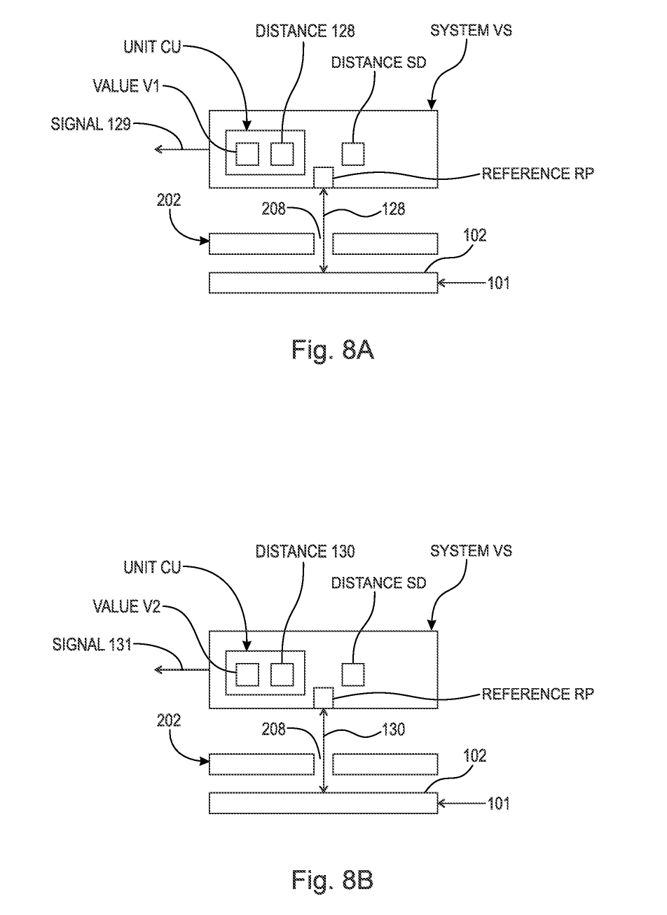

FIG. 8A illustrates an example of a proper circumferential alignment of bearing 100 and top mount 200. Vision system VS can be used to evaluate the proper alignment and connection of bearing 100 and mount 200. Vision system VS can be any vision system known in the art, including, but not limited to a laser-based system. System VS includes computation unit CU, which can be any computational device known in the art, to implement the computation and communication functions described for system VS. System VS measures a distance between reference point RP for system VS and surface 102. However, the accuracy of system VS is limited by sensitivity distance SD of the system, which is the smallest incremental distance the system can calculate/measure. Thus, an actual distance equal to a whole number multiple of sensitivity distance SD plus a fraction of sensitivity distance SD is measured as only the whole number multiple of sensitivity distance SD (fractions of sensitivity distance SD are truncated). Stated otherwise, system VS measures distance in whole number multiples of the distance SD.

System VS calculates distance 128, between reference point RP and surface 102 as equal to (m×sensitivity distance SD), where m is an integer. When VS calculates distance 128 as equal to (m×sensitivity distance SD), system VS calculates that strut bearing cap 101 and top mount 200 are properly aligned in circumferential direction CD. In an example embodiment, system VS transmits signal 129 indicating that strut bearing cap 101 and top mount 200 are aligned in circumferential direction CD. In an example embodiment, value V1 for (m×sensitivity distance SD) is stored in unit CU, and CU compares distance 128 to value V1 to calculate that proper alignment has occurred.

FIG. 8B illustrates an improper circumferential alignment of bearing 100 and top mount 200. Bolts 206 have contacted surfaces 110. The contact of bolts 206 with surfaces 110 has prevented bolt heads 207 from extending past surface 102 in direction AD2, separating surface 102 from reference point RP further than is the case in FIG. 8A. Vision system VS calculates distance 130, between reference point RP and surface 102, equal to (n×sensitivity distance SD), where n is an integer greater than integer m. When VS calculates that distance 130 is equal to (n×sensitivity distance SD), system VS transmits signal 131 indicating that an improper circumferential alignment has occurred, that is, strut bearing cap 101 and top mount 200 are misaligned in circumferential direction CD. In an example embodiment, value V2 for (n×sensitivity distance SD) is stored in unit CU, and CU compares distance 130 to value V2 to calculate that improper alignment has occurred. Thus, the difference between distances 128 and 130 is equal to at least sensitivity distance SD and is discernable by system VS.

Advantageously, bearing 100, in particular cap 101, solves the problem noted above regarding recognition of an improper circumferential alignment of a strut bearing and a top mount. In particular, instead of ribs 104 slanting directly from surface 102 to circumference 116, rib radial surfaces 110 extend radially from surface 102 to slant surfaces 112, which slant to circumference 116. Thus, surfaces 110 extend further in direction AD1 than the slanted surfaces for prior art strut caps and distance 130 is increased such that the difference between distances 128 and 130 is at least equal to sensitivity distance SD. Therefore, system VS is able to distinguish between a proper and an improper circumferential alignment of bearing 100 and top mount 200 and flag misaligned occurrences of bearing 100 and mount 200 as being defective. Thus, system VS is able to correctly calculate and identify the circumferential misalignment represented in FIG. 8B. Therefore, system VS is able to reject assemblies including misaligned bearings 100 and mounts 200 before the assemblies proceed any further in the fabrication process, reducing fabrication time and costs.

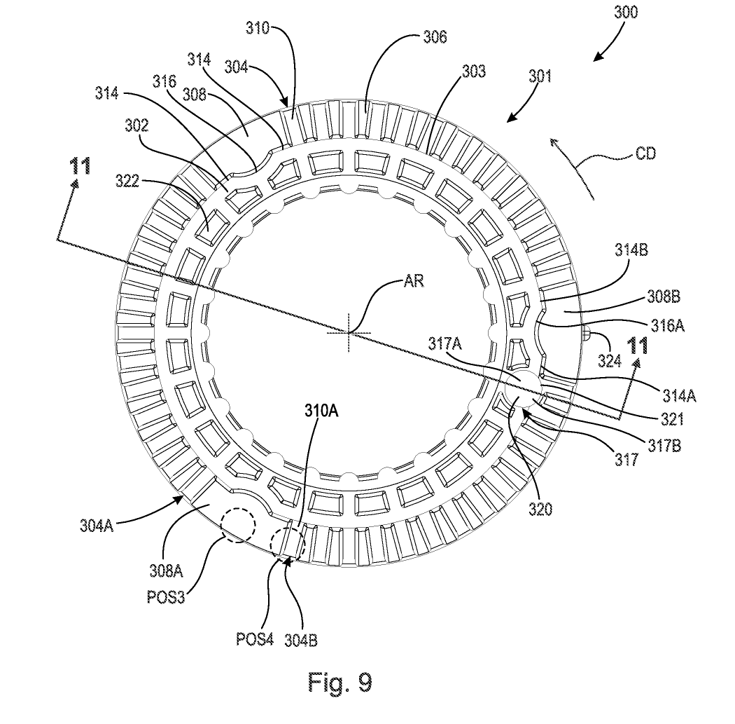

FIG. 9 is a top view of strut bearing 300 with an assembly feature.

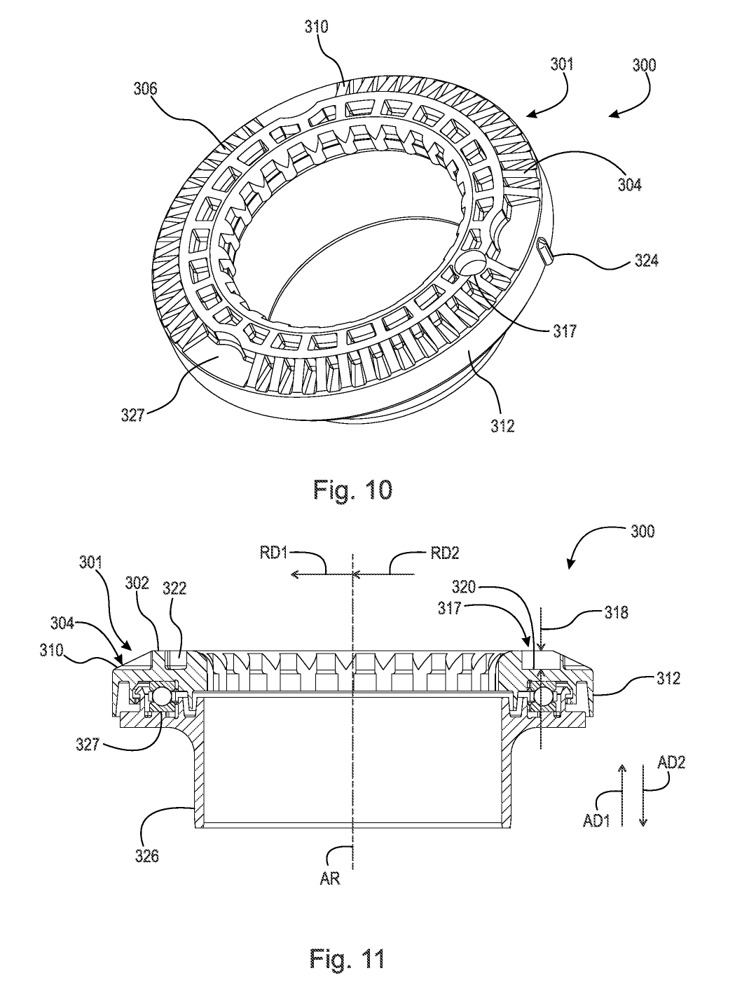

FIG. 10 is a perspective view of strut bearing 300 in FIG. 9.

FIG. 11 is a cross-sectional view generally along line 11-11 in FIG. 9. The following should be viewed in light of FIGS. 9 through 11. Strut bearing 300 includes axis of rotation AR and cap 301. Cap 301 includes: radial surface 302 facing in axial direction AD1 and including radially outermost edge 303; ribs 304 extending radially outwardly from edge 303 of radial surface 302; spaces 306; and radial recess surfaces 308. Each rib 304 includes slant surface 310 extending from surface 302 partly radially outwardly in radial direction RD1 and partly in axial direction AD2. Each space 306 is circumferentially disposed between a respective pair of ribs 304. Each radial recess surface 308: faces in axial direction AD1; is circumferentially disposed between two respective ribs 304; and is off-set, in axial direction AD2, from radial surface 302. For example, surface 308A is circumferentially disposed between ribs 304A and 304B. In an example embodiment, each slant surface 310 is directly connected to radial surface 302.

Cap 301 includes radially outermost circumferential surface 312. In an example embodiment, spaces 306 are open to radially outermost circumferential surface 312. In an example embodiment, ribs 304 extend to surface 312.

Circumferential walls 314 directly connect radial recess surfaces 308 to radial surface 302. In an example embodiment, curved walls 316: are circumferentially disposed between a respective pair of circumferential walls 314; are directly connected to the respective pair of circumferential walls 314; are directly connected to radial surface 302 and a respective surface 308; and extend radially inwardly in radial direction RD2 from the respective pair of circumferential walls 314. For example, wall 316A is circumferentially disposed between and directly connected to circumferential walls 314A and 314B; is directly connected to radial surface 302 and radial recess surface 308B; and extends radially inwardly from circumferential walls 314A and 314B. In an example embodiment, radial recess surfaces 308 extend to radially outermost circumferential surface 312.

Cap 301 includes measurement indentation 317 in surface 302 and extending distance, or depth, 318 in direction AD2 past surface 302. Surface 320, facing in direction AD1, bounds indentation 317 in direction AD2. In an example embodiment: portion 317A of indentation 317 is radially inward of ribs 304 or is in surface 302; and portion 317B of indentation 317 is circumferentially aligned with ribs 304. In an example embodiment, edge 321 of indentation 317 forms a portion of edge 303. In an example embodiment, bearing 300 includes indentations 322 in surface 302, circumferentially disposed about axis AR. Indentations 322 extend past surface 302 in direction AD2. In an example embodiment, surface 312 includes protrusion 324 extending radially outwardly. Protrusion 324 is used to manually align bearing 300 during the process of connecting bearing 300 to top mount 200.

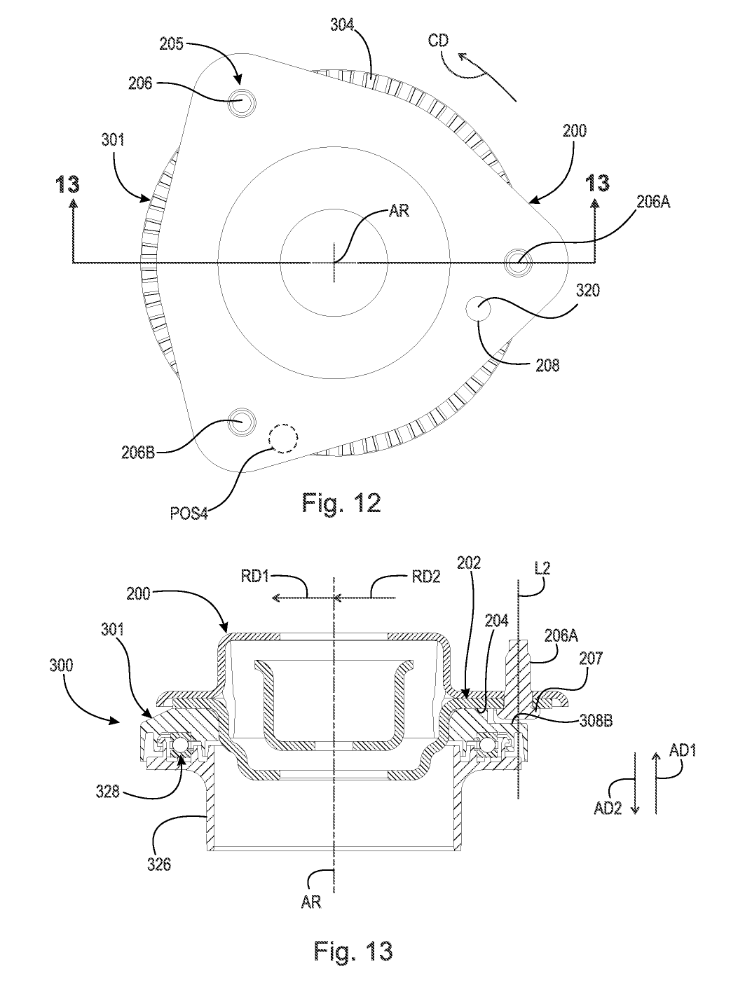

FIG. 12 is a top view of strut bearing 300, including cap 301, in FIGS. 9 through 11, connected to top mount 200 for a strut assembly and with strut bearing 300 properly circumferentially aligned with top mount 200.

FIG. 13 is a cross-sectional view generally along line 13-13 in FIG. 12. The following should be viewed in light of FIGS. 9 through 13. Bearing 300 includes body portion 326 and bearing 327 between cap 301 and portion 326. In an example embodiment, bearing 327 is a roller bearing. Mount 200 includes: portion 202 with surface 204 facing in direction AD2; and portion 205. Bolts 206 with bolts heads 207 extend through portion 202 and past surface 204 in direction AD2. During fabrication of a strut assembly, top mount 200 is press-fitted with bearing 300, in particular with cap 301. To implement the press fit, bearing 300 is moved in axial direction AD1 toward mount 200 or mount 200 is moved in direction AD2 toward bearing 300. If bearing 300 and mount 200 are properly aligned in circumferential direction CD, for example as shown in FIGS. 12 and 13, an entirety of bolts 206 and bolt heads 207, is axially aligned with and overlaps, in directions AD1 and AD2, respective surfaces 308. Bolts 206 and bolt heads 207 extend past surfaces 302 and 310 in direction AD2 without contacting surface 302 or 310. For example, every line parallel to axis AR, passing through a bolt head 207 also passes through a respective surface 308, for example, every line L2 passing through bolt head 207 for bolt 206A also passes through surface 308B.

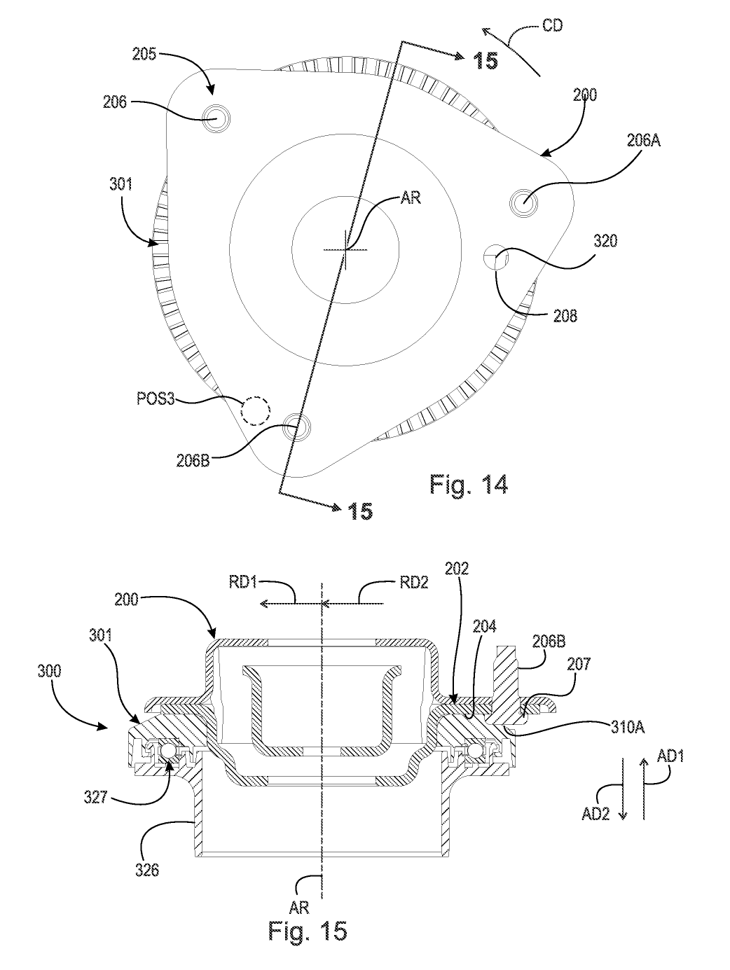

FIG. 14 a top view of strut bearing 300 in FIGS. 9 through 11 connected to top mount 200 for a strut assembly and with strut bearing 300 circumferentially misaligned with top mount 200.

FIG. 15 is a cross-sectional view generally along line 15-15 in FIG. 14. The following should be viewed in light of FIGS. 9 through 15. In FIGS. 14 and 15, a circumferential misalignment of mount 200 with bearing 300 is depicted. As shown in FIG. 15, bolt 206B has contacted surface 310A for rib 304B instead of being axially aligned with surface 308A.

Advantageously, bearing 300, in particular cap 301, solves the problem noted above regarding recognition of an improper circumferential alignment of a strut bearing with a top mount. In particular, as further described below, indentation 317 and surface 320 provide a reference surface which system VS can use to distinguish between the proper circumferential alignment shown in FIGS. 12 and 13 and the improper circumferential alignment shown in FIGS. 14 and 15.

To illustrate the difference between proper and improper alignments of bearing 300 and mount 200, we turn to FIG. 9. In FIG. 9, position POS3, shown with dashed lines, shows the proper circumferential alignment of bolt 206B with surface 308A (see FIGS. 12 and 13). In FIG. 9, position POS4, shown with dashed lines, shows an example of a circumferential misalignment between bearing 300 and mount 200, which results in bolt 206B contacting surface 310A of rib 304B (see FIGS. 14 and 15). Note that although not shown in FIG. 9, for POS4, all of bolts 206 would be shifted in direction CD (matching the shift of bolt 206B) with respect to the proper alignment of FIGS. 12 and 13. It should be understood that other degrees of misalignment between cap 301 and mount 200 in direction CD are possible and that misalignment between cap 301 and mount 200 is possible in a direction opposite direction CD.

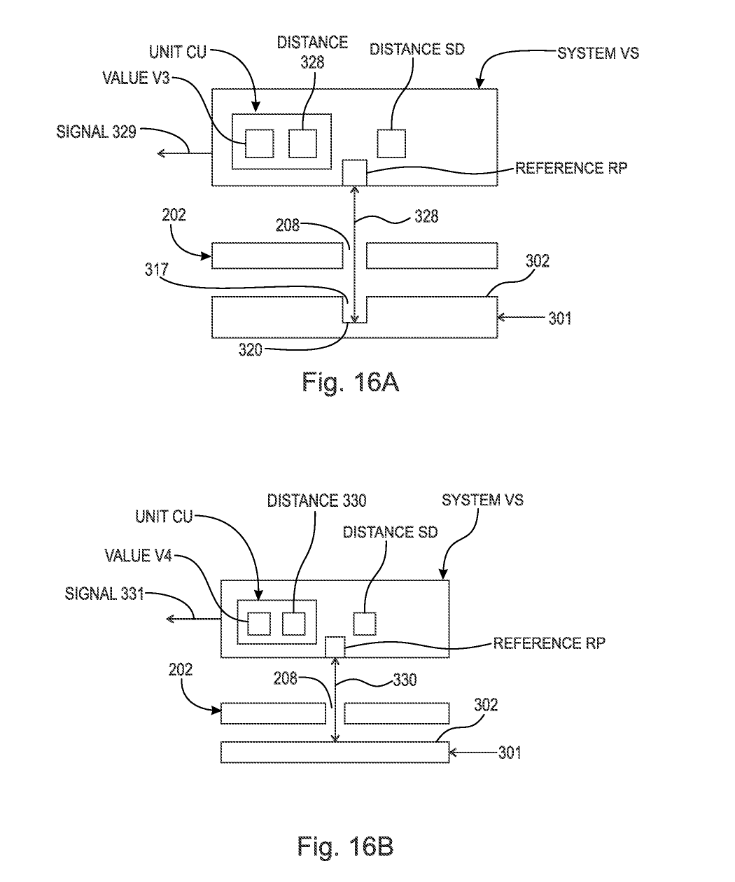

FIGS. 16A and 16B are respective schematic block diagrams. The following should be viewed in light of FIGS. 9 through 16B. Vision system VS, described above, is used to evaluate the proper alignment and connection of bearing 300 and mount 200. System VS is used to measure a distance between reference point RF and a reference surface on cap 301. In FIG. 16A, which illustrates an example of a proper circumferential alignment of bearing 300 and top mount 200, surface 320 includes the reference surface. Vision system VS calculates distance 328, between reference point RP and surface 320 as (p×sensitivity distance SD) where p is an integer. In an example embodiment, when system VS calculates that distance 328 is (p×sensitivity distance SD), system VS transmits signal 329 indicating that a proper circumferential alignment between cap 301 and top mount 200 has occurred. In an example embodiment, value V3 for (p×sensitivity distance SD) is stored in unit CU, and unit CU compares distance 328 to value V3 to calculate that proper circumferential alignment has occurred.

In FIG. 16B, which illustrates an improper circumferential alignment of bearing 300 and top mount 200: bolts 206, in particular bolt heads 207, have contacted surfaces 310; and surface 302 includes the reference surface. That is, opening 208 is not aligned with surface 320 in direction AD2. Vision system VS calculates distance 330, between reference point RP and surface 302, equal to (q×sensitivity distance SD), where q is an integer less than integer p. As shown in the example of FIGS. 14 and 15, although the contact of bolts 206 with surfaces 310 has prevented bolts 206 from extending past surface 302, and separates surface 302 from reference point RP further than is the case in FIG. 16A, depth 318 results in distance 328 still being greater than distance 330 by at least sensitivity distance SD.

In an example embodiment, when VS calculates that distance 330 is equal to (q×sensitivity distance SD), system VS transmits signal 331 indicating that an improper circumferential alignment between cap 301 and top mount 200 has occurred. In an example embodiment, value V4 for (q×sensitivity distance SD) is stored in unit CU, and unit CU compares distance 330 to value V4 to calculate that improper circumferential alignment has occurred. Thus, the difference between distances 328 and 330 is equal to at least sensitivity distance SD and is discernable by system VS.

Advantageously, since distance 328 is increased such that the difference between distances 328 and 330 is at least equal to sensitivity distance SD, system VS is able to distinguish between a proper and an improper circumferential alignment of bearing 300 and top mount 200 and flag misaligned occurrences of bearing 300 and mount 200 as being defective. Thus, system VS is able to correctly calculate the misalignment shown in FIGS. 14 and 15. Therefore, system VS is able to reject assemblies including misaligned bearings 300 and mounts 200 before the assemblies proceed any further in the fabrication process, reducing fabrication time and costs.

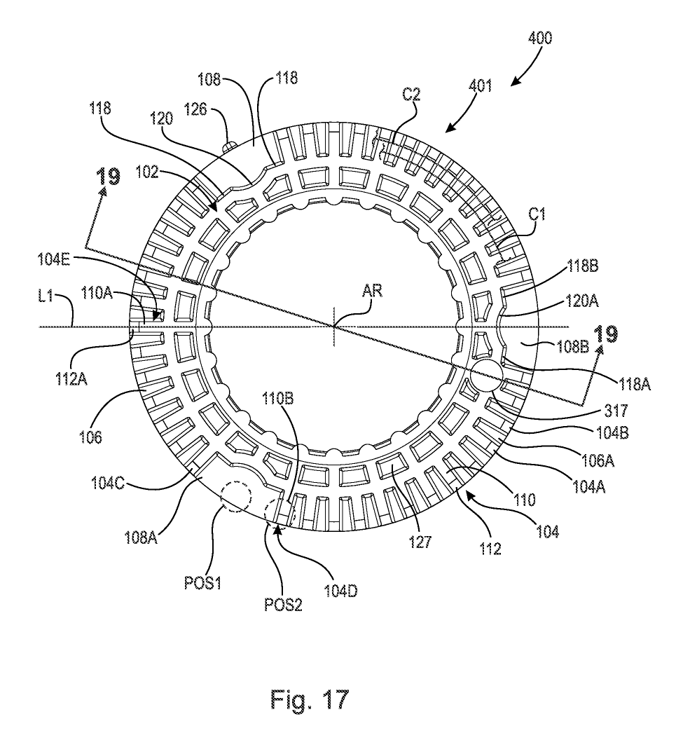

FIG. 17 is a top view of strut bearing 400 with two assembly features.

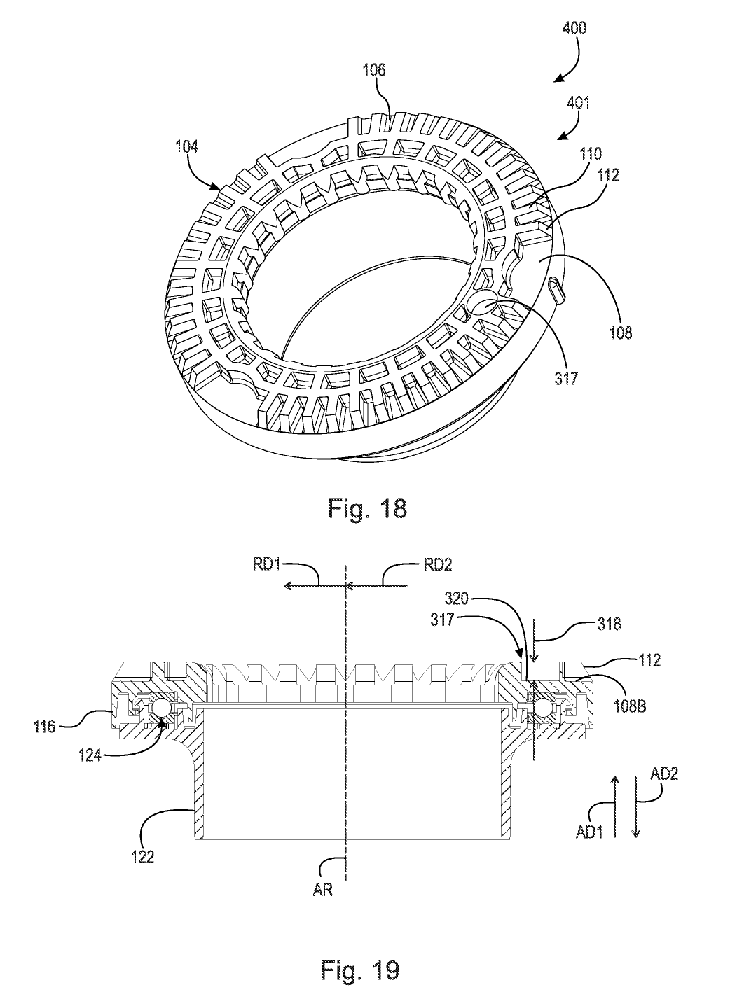

FIG. 18 is perspective view of strut bearing 400 in FIG. 17.

FIG. 19 is a cross-sectional view generally along line 19-19 in FIG. 17. The following should be viewed in light of FIGS. 1 through 19. Unless stated otherwise, the discussion and description for FIGS. 1 through 5 and strut bearing 100 is applicable to strut bearing 400. Strut bearing 400 adds indentation 317, shown in FIGS. 9 through 11 to cap 101 shown in FIGS. 1 through 3. Indentation 317 extends distance, or depth, 318, in direction AD2, from surface 102 and is bounded by radial surface 320 in direction AD2.

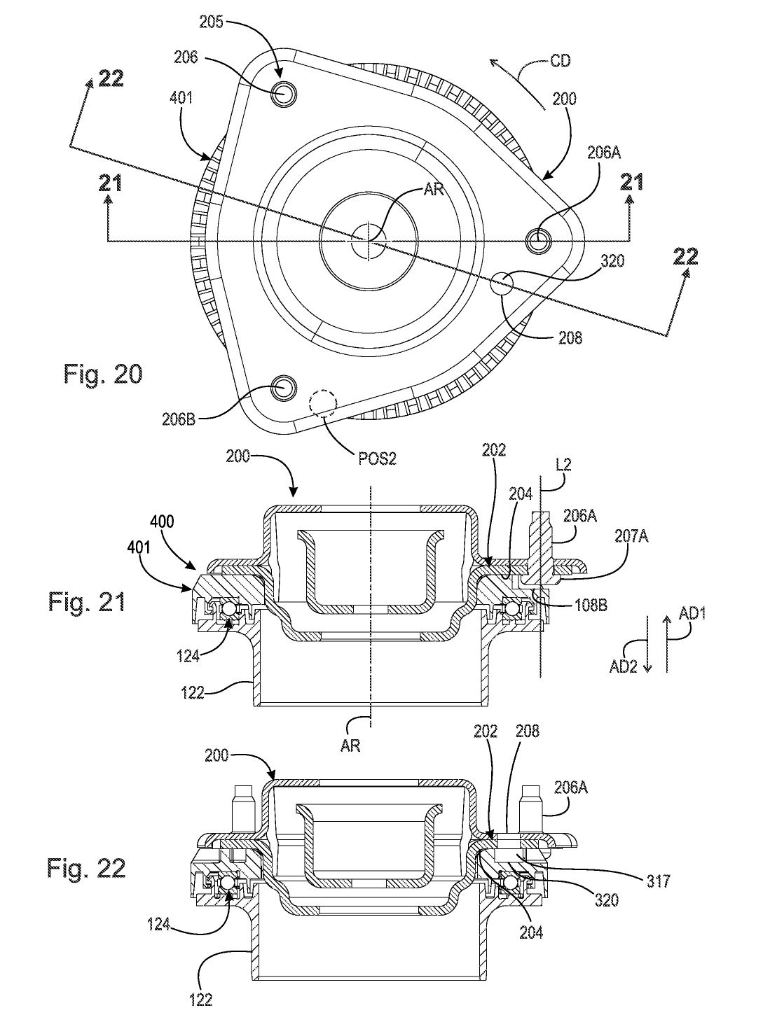

FIG. 20 is a top view of strut bearing 400 in FIGS. 17 through 19 connected to top mount 200 for a strut assembly and with strut bearing 400 properly circumferentially aligned with the top mount.

FIG. 21 is a cross-sectional view generally along line 21-21 in FIG. 20.

FIG. 22 is a cross-sectional view generally along line 22-22 in FIG. 20. The following should be viewed in light of FIGS. 1 through 22. Mount 200 includes: portion 202 with surface 204 facing in direction AD2; and portion 205. Bolts 206 extend through portion 202 and past surface 204 in direction AD2. During fabrication of a strut assembly, top mount 200 is press-fitted with bearing 400, in particular with cap 401. To implement the press fit, bearing 400 is moved in axial direction AD1 toward mount 200 or mount 200 is moved in direction AD2 toward bearing 400. If bearing 400 and mount 200 are properly aligned in circumferential direction CD, for example as shown in FIGS. 21 and 22, an entirety of bolts 206 and bolt heads 207 is axially aligned with and overlaps, in directions AD1 and AD2, respective surfaces 108. Bolts 206 and bolt heads 207 extend past surfaces 102 and 110 in direction AD2 without contacting surface 102 or 110. For example, every line parallel to axis AR, passing through a bolt head 207 also passes through a respective surface 108, for example, every line L2 passing through bolt head 207 for bolt 206A also passes through surface 108B.

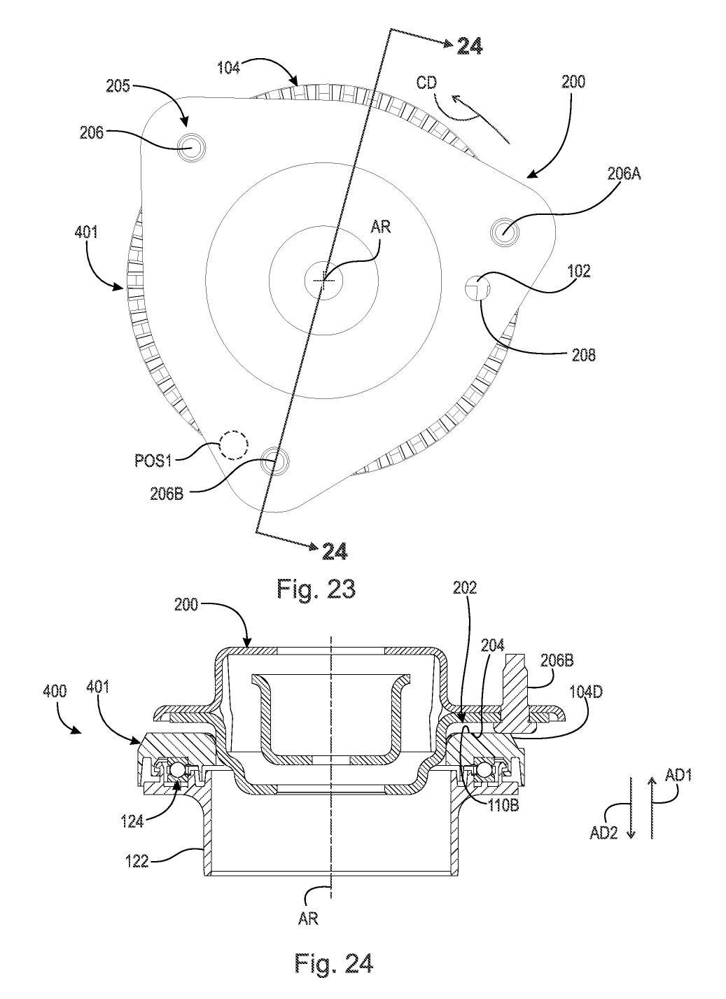

FIG. 23 is a top view of strut bearing 400 in FIGS. 17 through 19 connected to top mount 200 for a strut assembly and with strut bearing 400 circumferentially misaligned with top mount 200.

FIG. 24 is a cross-sectional view generally along line 24-24 in FIG. 23. The following should be viewed in light of FIGS. 1 through 24. In FIGS. 23 and 24, a circumferential misalignment of mount 200 with bearing 400 is depicted. As shown in FIG. 24, bolt head 207 for bolt 206B has contacted surface 110B for rib 104D instead of being axially aligned with surface 108A.

Advantageously, bearing 400, in particular cap 401, solves the problem noted above regarding recognition of an improper circumferential alignment of a strut bearing and a top mount. In particular, instead of ribs 104 slanting directly from surface 102 to circumference 116, rib radial surfaces 110 extend radially from surface 102 and then slant surfaces 112 slant to circumference 116. Further, indentation 317 and surface 320 provide a reference surface which system VS can use to distinguish between a proper circumferential alignment shown in FIGS. 20 through 22 and an improper circumferential alignment shown in FIGS. 22 and 24.

To illustrate the difference between proper and improper circumferential alignments of bearing 400 and mount 200, we turn to FIG. 17. In FIG. 17, position POS1, shown with dashed lines, shows the proper alignment of bolt 206B with surface 108A. In FIG. 17, position POS2, shown with dashed lines, shows an example of a circumferential misalignment between bearing 400 and mount 200, which results in bolt 206B contacting surface 110B of rib 104D. Note that although not shown in FIG. 17, for POS2, all of bolts 206 would be shifted in direction CD (matching the shift of bolt 206B) with respect to the proper alignment of FIGS. 20 through 22. It should be understood that other degrees of misalignment between cap 401 and mount 200 in direction CD are possible and that misalignment between cap 401 and mount 200 is possible in a direction opposite direction CD.

Vision system VS, described above, is used to evaluate the proper alignment and connection of bearing 400 and mount 200. In particular, system VS measures a distance between point RP and a reference surface on cap 401.

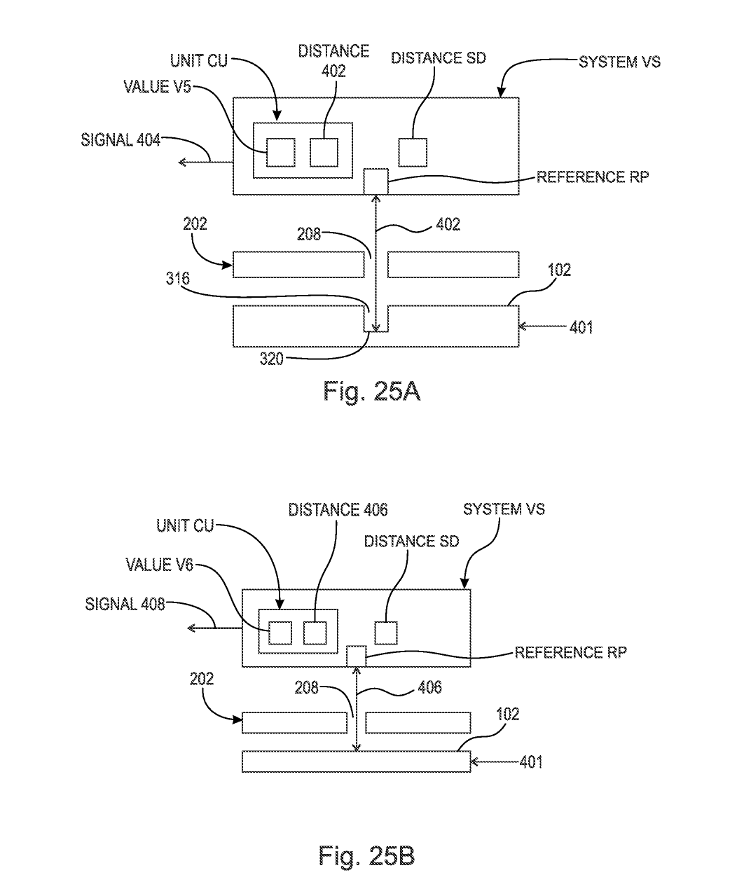

FIGS. 25A and 25B are respective schematic block diagrams. The following should be viewed in light of FIGS. 1 through 25B. In FIG. 25A, which illustrates an example of a proper circumferential alignment of bearing 400 and top mount 200, surface 320 includes the reference surface noted above. Vision system VS is used to evaluate the proper circumferential alignment and connection of bearing 400 and mount 200. Vision system VS calculates distance 402, between reference point RP and surface 320 as (r×sensitivity distance SD) where r is an integer. In an example embodiment, when VS calculates that distance 402 is equal to (r×sensitivity distance SD), system VS transmits signal 404 indicating that a proper circumferential alignment has occurred between cap 401 and top mount 200. In an example embodiment, value V5 for (r×sensitivity distance SD) is stored in unit CU, and unit CU compares measured distance 402 to value V5 to calculate that proper circumferential alignment has occurred.

In FIG. 25B, which illustrates an improper circumferential alignment of bearing 400 and top mount 200, surface 102 includes the reference surface noted above, and bolt heads 207 have contacted surfaces 110. Vision system VS calculates distance 406, between reference point RP and surface 102, as (s×sensitivity distance SD) where s is an integer less than integer r. Thus, in the example of FIG. 25B, although the contact of bolts 206 with surfaces 110 has prevented the bolts from extending past surface 102, and separates surface 102 and reference point RP further than is the case in FIG. 25A, depth 318 results in distance 406 still being greater than distance 402 by at least distance SD.

In an example embodiment, when VS calculates that distance 406 is (s×sensitivity distance SD), system VS transmits signal 408 indicating that an improper circumferential alignment has occurred. In an example embodiment, value V6 for (s×sensitivity distance SD) is stored in unit CU, and unit CU compares distance 406 to value V6 to calculate that proper alignment has occurred. The difference between distances 402 and 406 is equal to at least sensitivity distance SD and is discernable by system VS.

Advantageously, since distance 402 is increased such that the difference between distances 402 and 406 is at least equal to sensitivity distance SD, system VS is able to distinguish between a proper and an improper circumferential alignment of bearing 400 and top mount 200 and flag circumferentially misaligned occurrences of bearing 400 and mount 200 as being defective. Thus, system VS is able to correctly calculate the circumferential misalignment represented in FIGS. 23 and 24. Therefore, due to the configuration of bearing 400, system VS is able to detect and reject assemblies including a circumferentially misaligned strut bearing 400 and top mount 200 before the assemblies proceed any further in the fabrication process, reducing fabrication time and costs.

The combination of rib radial surfaces 110 and indentation 317 for cap 401 is particularly advantageous when sensitivity distance SD for system VS is greater than the difference between distances 128 and 130, or 328 and 330. That is, when system VS is not able to accurately detect a misalignment between a top mount and strut bearing 100 or strut bearing 300. Stated otherwise, distance 402 is at least equal to distance SD and is greater than distance 128 or 328.

The following should be viewed in light of FIGS. 1 through 8B. The following describes a method of mounting strut bearing cap 100 onto a strut assembly. Although the method is presented as a sequence of steps for clarity, no order should be inferred from the sequence unless explicitly stated. A first step displaces strut bearing 100 toward top mount 200, or displaces top mount 200 toward strut bearing 100. A second step: extends, in axial direction AD2, bolts 206 past radial rib surfaces 110; or contacts bolts 206 with respective radial rib surfaces 110 and transmits, with vision system VS, signal 131 that that an improper circumferential alignment of strut bearing cap 101 with top mount 200 has occurred.

When bolts 206 extend, in axial direction AD2, past radial rib surfaces 110, a third step calculates, with vision system VS, distance 128, in axial direction AD2 and between reference point RP radial surface 102, as being equal to (m×sensitivity distance SD), where m is an integer. In an example embodiment, in a fourth step, in response to distance 128, system VS transmits signal 129 that a proper circumferential alignment of cap 101 and top mount 200 has occurred. Sensitivity distance SD is the smallest incremental distance vision system VS can calculate or measure.

When bolts 206 contact radial rib surfaces 110, a fifth step calculates, with vision system VS, distance 130, in axial direction AD2 and between reference point RP and radial surface 102, as being equal to (n×sensitivity distance SD), wherein n is an integer greater than integer m. In an example embodiment, the improper circumferential alignment of strut bearing cap 100 with top mount 200 includes an entirety of bolts 206 failing to overlap recessed radial surfaces 108 in direction AD1 or AD2.

The following should be viewed in light of FIGS. 9 through 16B. The following describes a method of mounting strut bearing cap 300 onto a strut assembly. Although the method is presented as a sequence of steps for clarity, no order should be inferred from the sequence unless explicitly stated. A first step displaces strut bearing 100 toward top mount 200, or displaces top mount 200 toward strut bearing 100. A second step contacts cap 301 with mount 200. A third step: calculates, with vision system VS, distance 328, in axial direction AD2, between reference point RP and radial surface 320 and confirms with vision system VS and using distance 328, that radial recess surfaces 108 and an entirety of bolts 206 overlap in axial direction AD1; or calculates with vision system VS, distance 330, in axial direction AD2, between reference point RP and radial surface 102, calculates, with vision system VS and using distance 330, that bolts 206 are in contact with respective ribs 304; and transmits, with vision system VS, signal 331 that an improper circumferential alignment of strut bearing cap 301 with top mount 200 has occurred. Sensitivity distance SD is the smallest incremental distance vision system VS can calculate or measure. The difference between distances 328 and 330 is equal to at least sensitivity distance SD.

In an example embodiment, in a fourth step, system VS, based on measurement 328, transmits signal 329 that strut bearing cap 301 and top mount 200 are aligned in a circumferential direction.

The following should be viewed in light of FIGS. 17 through 25B. The following describes a method of mounting strut bearing cap 400 onto a strut assembly. Although the method is presented as a sequence of steps for clarity, no order should be inferred from the sequence unless explicitly stated. A first step displaces one of strut bearing cap 401 or top mount 200 toward the other of strut bearing cap 401 or top mount 200. A second step contacts cap 401 with top mount 200. A third step calculates, with vision system VS, a distance in axial direction AD2, between reference point RP and a reference surface on cap 401. A fourth step calculates, with system VS and when radial surface 320 includes the reference surface, that that bolts 206 extends past radial rib surfaces 110 in axial direction AD2; or a fourth step calculates with vision system VS and when radial surface 102 includes the reference surface that bolts 206 are in contact with surfaces 110 and transmits signal 408 that an improper circumferential alignment of bearing 400 and mount 200 has occurred. Sensitivity distance SD is the smallest incremental distance vision system VS can calculate or measure.

In an example embodiment, when radial surface 320 includes the reference surface, in a fifth step, vision system VS transmits signal 403 that that strut bearing cap 401 and top mount 200 are properly aligned in the circumferential direction.

In an example embodiment: a sixth step calculates, with system VS and when radial surface 320 includes the reference surface, that distance 402 is equal to (r×sensitivity distance SD), with r being an integer. In an example embodiment: a seventh step calculates, with system VS and when radial surface 102 includes the reference surface, that distance 404 is equal to (s×sensitivity distance SD), with s being an integer less than r.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

10 cylindrical system
11 axis of rotation
AD1 axial direction
AD2 axial direction
RD1 radial direction
RD2 radial direction
CD1 circumferential direction
CD2 circumferential direction
R radius
12 object
13 object
14 object
15A surface
15B surface
15C edge
16A surface
16B edge
17A radius
17B radius
18 surface
19 circumference
20 radius
C1 circle
C2 circle
CU computation unit
L1 line
L2 line
m integer
n integer
p integer
POS1 position
POS2 position
POS3 position
POS4 position
q integer
RP reference point
SD sensitivity distance
V1 value
V2 value
V3 value V2
V4 value
V5 value
V6 value
VS vision system
100 strut bearing
102 radial surface
104 rib
104A rib
104B rib
104C rib
104D rib
104E rib
106 space
106A space
108 recess surface
108A recess surface
108B recess surface
110 rib surface
110A rib surface
110B rib surface
112 slant surface
112A slant surface
114 acute angle
116 circumferential surface
118 circumferential wall
118A circumferential wall
118B circumferential wall
120 circumferential wall
120A circumferential wall
122 body portion
124 bearing
126 protrusion
127 indentation
128 distance
129 signal
130 distance
131 signal
200 top mount
202 portion
204 surface
205 portion
206 bolts
206A bolt
206B bolt
207 bolt head
300 strut bearing
302 radial surface
303 edge
304 rib
304A rib
304B rib
306 space
308 recess surface
308A recess surface
308B recess surface
310 slant surface
310A slant surface
312 circumferential surface
314 circumferential wall
314A circumferential wall
314B circumferential wall
316 curved wall
316A curved wall
317 measurement indentation
317A portion of indentation 317
317B portion of indentation 317
318 distance
320 surface
322 indentation
324 protrusion
326 body portion
327 bearing
328 distance
329 signal
330 distance
331 signal
400 strut bearing
401 cap
402 distance
404 signal
406 distance
408 signal

1. A strut bearing, comprising:
an axis of rotation; and,
a cap including:
a first radial surface facing in a first axial direction;
a plurality of ribs, each rib including:
a radial rib surface extending radially outwardly from the first radial surface; and,
a slant surface extending from the radial rib surface:
partly radially outwardly; and,
partly in a second axial direction, opposite the first axial direction;
a plurality of spaces, each space circumferentially disposed between a respective pair of ribs; and,
a plurality of radial recess surfaces, each radial recess surface:
facing in the first axial direction;
circumferentially disposed between two respective ribs; and,
off-set, in the second axial direction, from the first radial surface;
a body portion; and,
a bearing fixed to the strut bearing cap and to the body portion.

2. The strut bearing of claim 1, wherein:
a first circle, centered on the axis of rotation, is co-linear with the radial rib surfaces; and,
a second circle, centered on the axis of rotation and axially off-set from the first circle, is co-linear with the slant surfaces.

3. The strut bearing of claim 1, wherein a line orthogonal to the axis of rotation is:
co-linear with the first radial surface and with a first radial rib surface; and,
forms an acute angle with a first slant surface.

4. The strut bearing of claim 1, wherein each radial rib surface is directly connected to the first radial surface.

5. The strut bearing of claim 1, wherein:
the strut bearing cap includes a radially outermost circumferential surface; and,
the plurality of spaces is open to the radially outermost circumferential surface.

6. The strut bearing of claim 1, wherein the strut cap includes a plurality of circumferential walls directly connecting the plurality of radial recess surfaces to the first radial surface.

7. The strut bearing of claim 6, wherein the strut bearing cap includes a plurality of curved walls, each curved wall:
circumferentially disposed between a respective pair of circumferential walls;
directly connected to the respective pair of circumferential walls;
directly connected to the first radial surface and to a respective recess radial surface; and,
extending radially inwardly from the respective pair of circumferential walls.

8. The strut bearing of claim 1, wherein:
the strut bearing cap includes a radially outermost circumferential surface; and,
the plurality of radial recess surfaces extends to the radially outermost circumferential surface; or,
the plurality of ribs extends radially outwardly to the radially outermost circumferential surface.

9. The strut bearing of claim 1, wherein the strut bearing cap includes a radially outermost circumferential surface with a radially outwardly extending orientation protrusion.

10. The strut bearing of claim 1, wherein the strut bearing cap includes an indentation with:
a first portion in the first radial surface;
a second portion circumferentially aligned with the plurality of ribs; and,
the strut bearing cap includes a second radial surface bounding the indentation in the second axial direction.

11. A strut bearing, comprising:
an axis of rotation;
a cap including:
a radial surface facing in a first axial direction and including a radially outermost edge;
a plurality of ribs, each rib extending from the radially outermost edge partly radially outwardly, and partly in a second axial direction, opposite the first axial direction;
an indentation in the radial surface, the indention including an edge forming a portion of the radially outermost edge;
a plurality of spaces, each space circumferentially disposed between a respective pair of ribs; and,
a plurality of radial recess surfaces, each radial recess surface:
facing in the first axial direction;
circumferentially disposed between two respective ribs; and,
off-set, in the second axial direction, from the radial surface;
a body portion; and,
a bearing fixed to the strut bearing cap and to the body portion.

12. The strut bearing of claim 11, wherein:
a portion of the indention is radially inward of the plurality of ribs; or,
a portion of the indentation is circumferentially aligned with the plurality of ribs.

13. A strut bearing, comprising:
an axis of rotation; and,
a cap including:
a first radial surface facing in a first axial direction;
a plurality of ribs, each rib including:
a radial rib surface extending radially outwardly from the first radial surface; and,
a slant surface extending from the radial rib surface:
partly radially outwardly; and,
partly in a second axial direction, opposite the first axial direction;
an indentation extending in the second axial direction and with:
a first portion in the first radial surface or a first portion radially inward of the plurality of ribs; and,
a second portion circumferentially aligned with the plurality of ribs;
a plurality of spaces, each space circumferentially disposed between a respective pair of ribs; and,
a plurality of radial recess surfaces, each radial recess surface:
facing in the first axial direction;
circumferentially disposed between two respective ribs; and,
off-set, in the second axial direction, from the first radial surface;
a body portion; and,
a bearing fixed to the strut bearing cap and to the body portion.

14. A method of mounting the strut bearing recited in claim 1 onto a strut assembly, comprising:
displacing the strut bearing toward the top mount, or displacing the top mount toward the strut bearing; and,
extending, in the second axial direction, a plurality of bolts for the top mount past the radial rib surfaces; or,
contacting the plurality of bolts with respective radial rib surfaces and transmitting, with a vision system, a signal that an improper circumferential alignment of the strut bearing cap with the top mount has occurred.

15. The method of claim 14,
wherein when the plurality of bolts extends, in the axial direction, past the plurality of radial rib surfaces, the method further comprises:
calculating, with a vision system, that a first distance, in the second axial direction between a reference point for the vision system and the first radial surface is equal to (m×a sensitivity distance), wherein m is an integer, and the sensitivity distance of the vision system is the smallest incremental distance the vision system can calculate or measure; and,
wherein when the plurality of bolts contacts the first radial surface, the method further comprises:
calculating, with the vision system, a distance, in the second axial direction between a reference point for the vision system and the first radial surface, as being equal to (n×a sensitivity distance), wherein n is an integer larger than integer m.

16. The method of claim 14, wherein the improper circumferential alignment of the strut bearing cap with the top mount includes an entirety of the plurality of bolts failing to overlap the recessed radial surfaces in the first or second axial direction.

17. A method of mounting the strut bearing recited in claim 11 onto a strut assembly, comprising:
displacing the strut bearing toward the top mount, or displacing the top mount toward the strut bearing;
contacting the strut bearing cap with a portion of the top mount; and,
calculating, with a vision system, a first distance, in the second axial direction, between a reference point for the vision system and a second radial surface bounding the indentation in the second axial direction; and, confirming, with the vision system and using the first distance, that the radial recess surfaces and an entirety of a plurality of bolts for the top mount overlap in the first axial direction; or,
calculating, with a vision system, a second distance, in the second axial direction, between a reference point for the vision system and the first radial surface, confirming with the vision system and using the second distance that a plurality of bolts for the top mount is in contact with respective ribs, and transmitting with the vision system a signal that an improper circumferential alignment of the strut bearing cap with the top mount has occurred.

18. The method of claim 17, wherein:
a sensitivity distance of the vision system is the smallest incremental distance the vision system can calculate or measure; and,
the difference between the first and second distances is equal to at least the sensitivity distance.

19. A method of mounting the strut bearing recited in claim 13 onto a strut assembly, comprising:
displacing the strut bearing toward the top mount, or displacing the top mount toward the strut bearing;
contacting the strut bearing with the top mount;
calculating, with a vision system, a distance in the second axial direction, between a reference point for the vision system and a reference surface on the strut bearing cap; and,
when the second radial surface includes the reference surface, confirming, with the vision system and using the distance, that a plurality of bolts for the top mount extends past the radial rib surfaces in the second axial direction; or,
when the first radial surface includes the reference surface, confirming with the vision system and using the distance that a plurality of bolts for the top mount is in contact with the radial rib surfaces, and transmitting, with the vision system, a signal that an improper circumferential alignment of the strut bearing cap with the top mount has occurred.

20. The method of claim 19, wherein a sensitivity distance of the vision system is the smallest incremental distance the vision system can calculate or measure; the method further comprising:
when the second radial surface includes the reference surface, calculating, with the vision system, that the distance is equal to (r×the sensitivity distance), with r being an integer; and,
when the first radial surface includes the reference surface, calculating, with the vision system, that the distance is (s×the sensitivity distance), with s being an integer less than integer r.
